(19) United States
(12) Patent Application Publication
(10) Pub. No.: US 2013/0076916 A1
(43) Pub. Date: Mar. 28, 2013

(54) INTERACTIVE GRAPHIC CARD WITH A DIGITAL KEY AND ITS OPERATING METHOD

(71) Applicants: YU Hong-Chi, Kaohsiung City (TW); Chang Mao-Ting, Kaohsiung City (TW)

(72) Inventors: YU Hong-Chi, Kaohsiung City (TW); Chang Mao-Ting, Kaohsiung City (TW)

(73) Assignee: WALTON ADVANCED ENGINEERING INC., Kaohsiung (TW)

(21) Appl. No.: 13/311,749

(22) Filed: Dec. 6, 2011

(30) Foreign Application Priority Data
Sep. 22, 2011 (TW) 100134089

(51) Int. Cl. H04N 5/225

(52) U.S. Cl. 348/207.1; 348/E05.024

(57) ABSTRACT

The present invention is intended for supply of an interactive graphic card with a digital key & its operating method, an image signal which corresponds to an object displayed on one computer's display unit, and further improved interaction between the graphic card and one user who easily operates the computer equipped with one webcam to execute an image recognition application. Accordingly, the graphic card is effective in creation of innovative and novel feelings via the present invention in addition to preservation of original texts, sounds or messages.

### BACKGROUND OF THE INVENTION

1) Field of the Invention

The present invention relates to a graphic card, especially an interactive graphic card with a digital key and its operating method.

2) Description of the Prior Art

Most traditional paper cards (e.g., New Year card, birthday card, invention card, Christmas card, etc.) are printed with delicate patterns or compliments on surfaces or inside back covers, decorated with sophisticated ornaments, or further upgraded to music output or 3-dimensional patterns for some greetings written by a consigner and read by an addressee.

On the other hand, the Internet in an information era has become another channel by which messages with audiovisual effects could be delivered by people.

Despite a consigner's feeling of friendship or appreciation transferred to an addressee via the above manners, those traditional paper cards or e-cards are still short of innovation in either style or function, offer limited changeability or little interaction between a consigner and an addressee, and fail to bring more attraction for both parties in current atmosphere emphasizing innovation and originality.

Against this background, one device or product breaking through convention and delivering innovative or novel feelings or messages is waiting a manufacturer's development and creation.

### SUMMARY OF THE INVENTION

To solve the said problems, the present invention provides an interactive graphic card with a digital key and its operating method, which is simple and advantageous to interaction between an addressee and a graphic card, and is effective in communication of messages and creation of innovative & novel feelings.

To this end, the present invention has the principal technical measures delivered with the following techniques. The present invention is an interactive graphic card with a digital key and comprises a digital key, an image recognition application, a computer, a graphic card and a webcam: the digital key is provided with a USB connector, a memory unit and a control unit; the memory unit is used to supply readable/writable digital data and comprises an executive file/program; the control unit electrically connected between the memory unit and the USB connector is used to execute commands and control import/export of data flow; the image recognition application comprises computer image operation codes, data transfer codes and a computer graphics database; the computer is electrically connected to the digital key's USB connector via a USB port and executes the executive file/program in order to access and execute the image recognition application; the graphic card comprises an object which corresponds to an image signal of the computer graphics database; the webcam is used to access and provide the object to the computer, calculating any image signal which corresponds to one object via the computer image operation codes of the image recognition application and executing the data transfer codes to display the image signal on the computer's one display unit.

The purposes and the technical issues with respect to the present invention are further embodied with the following technical measures.

In the said interactive graphic card with a digital key, the memory unit comprises a website with web page codes in which the image recognition application is inserted.

In the said interactive graphic card with a digital key, the image signal to which the object corresponds is displayed on the website's one web page that can be shown on the computer's one display unit.

In the said interactive graphic card with a digital key, the control unit comprises a virtual device module which can be preset to be one virtual device among a CD-ROM drive, a floppy disk drive and a floppy disk.

In the present invention, the operating method of the said interactive graphic card with a digital key has some steps including: (1) Step a: The digital key's USB connector is electrically connected to the computer's USB port; (2) Step b: A demand for linking a virtual device from the control unit's virtual device module is issued to the computer which will automatically execute the executive file/program; (3) Step c: The image recognition application is installed into the computer by the executive file/program; (4) Step d: The image recognition application is executed by one user; (5) Step e: The object is accessed by the webcam and provided to the computer; (6) Step f: Computer image operation codes are executed to match an image signal and the corresponding object; (7) Step g: The image signal is displayed on the computer's one display unit by the data transfer codes.

The purposes and the technical issues with respect to the present invention are further embodied with the following technical measures.

In the said operating method of the interactive graphic card with a digital key, a default browser is called by the executive file/program for the website and the image recognition application is automatically downloaded to and executed in the computer after Step b.

In the said operating method of the interactive graphic card with a digital key, the image signal at Step g is displayed on the website's one corresponding web page which is shown on the computer's one display unit.

In contrast to the prior arts, the present invention with the simple operating method fulfills interaction between an addressee and a graphic card and is effective in communication of messages as well as creation of innovative and novel feelings.

### BRIEF DESCRIPTIONS OF THE DRAWINGS

FIG. 1 is the cross-sectional view of a digital key in the first embodiment for the present invention of an interactive graphic card with a digital key and its operating method.

FIG. 2 illustrates execution of the first embodiment for the present invention of an interactive graphic card with a digital key and its operating method.

FIG. 3 is the block diagram of the first embodiment for the present invention of an interactive graphic card with a digital key and its operating method.

FIG. 4 is the flow chart of the first embodiment for the present invention of an interactive graphic card with a digital key and its operating method.

FIG. 5 illustrates execution of the second embodiment for the present invention of an interactive graphic card with a digital key and its operating method.

### DETAILED DESCRIPTIONS OF THE PREFERRED EMBODIMENTS

For objects, characteristics, and effects obviously and easily understood, the preferred embodiments of the present invention are particularly interpreted as follows:

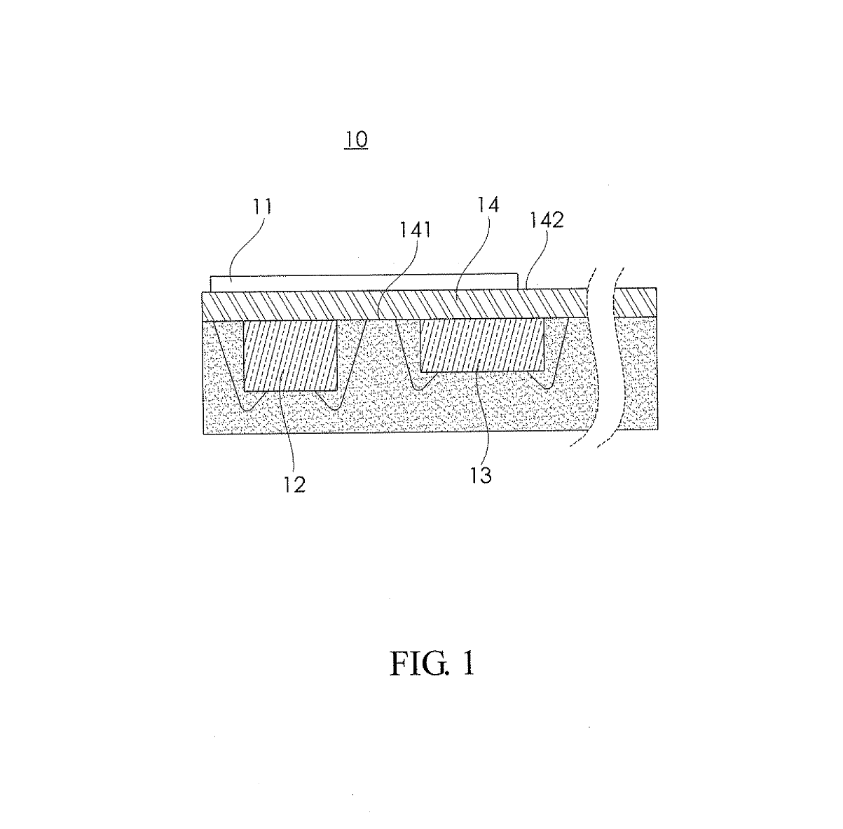

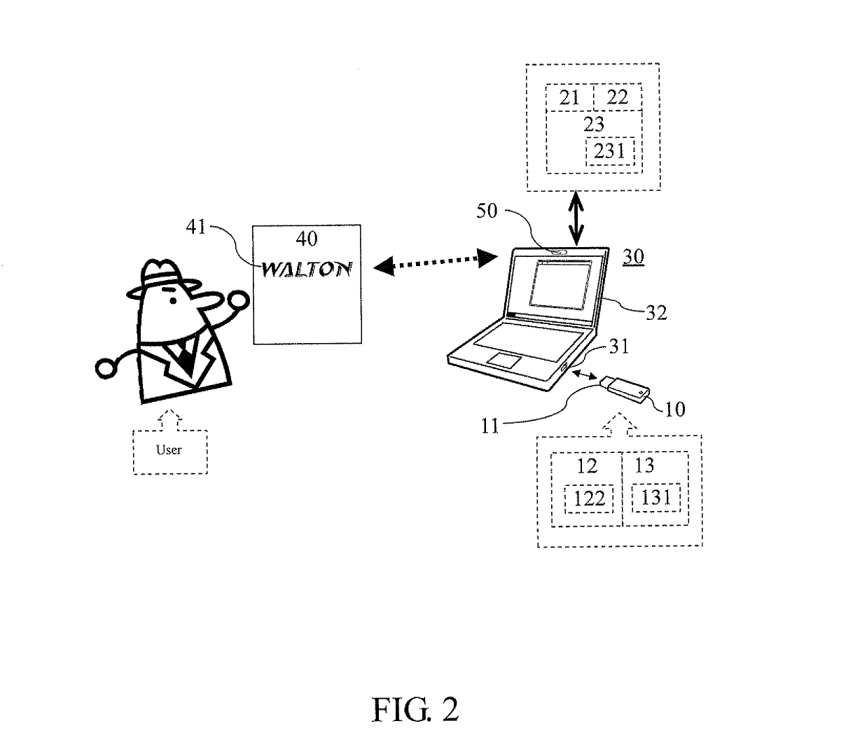

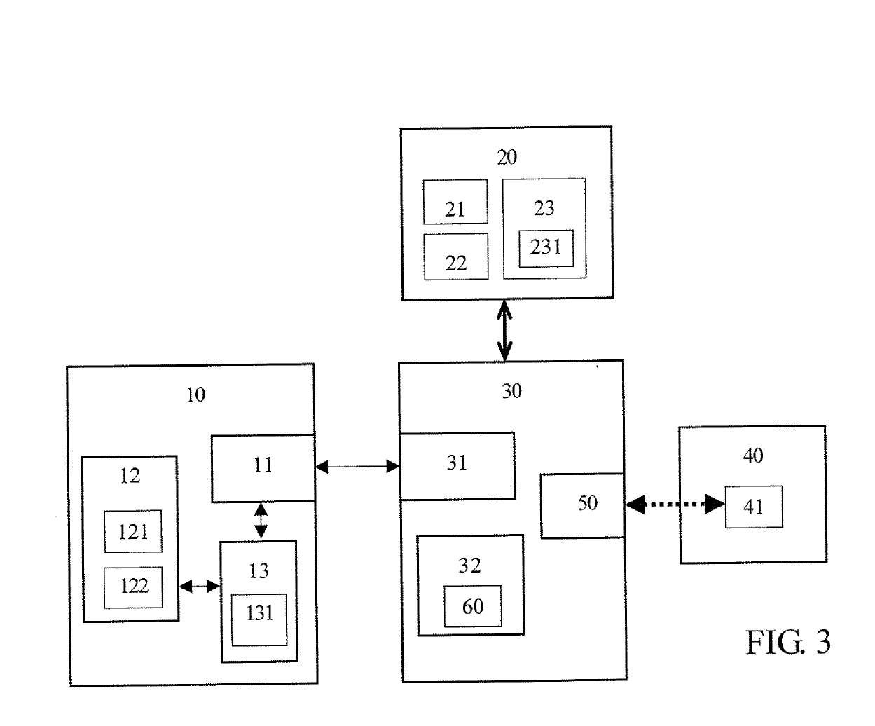

The first embodiment for the present invention of an interactive graphic card with a digital key and its operating method is shown in FIGS. 1˜4. Referring to FIGS. 1˜3 which illustrate the present invention comprises a digital key (10), an image recognition application (20), a computer (30), a graphic card (40), and a webcam (50). As shown in FIGS. 2 and 3, the icon “ ” implies an image recognition application accessed; the

[symbol]

icon “ [symbol] ” means electrical connection completed; the icon “ [symbol] ” implies the object accessed.

The digital key (10) comprises a USB connector (11), a memory unit (12) and a control unit (13). Specifically, the memory unit (12) and the control unit (13) are mounted on an inner surface (141) of a substrate (14) and a USB connector (11) is installed on an outer surface (142) of the substrate (14) in order to electrically link the memory unit (12), the control unit (13) and the USB connector (11) via electronic circuits (not shown in figures) on the substrate (14). In this regard, both the memory unit (12) and the control unit (13) are electrically connected to the substrate (14) by means of wire bonding or a flip chip technique (not shown in figures).

The USB connector (11) in this embodiment is compatible to the USB (Universal Serial Bus) data transfer interface series A male connector.

The memory unit (12) is used to provide readable/writable digital data and comprises an executive file/program (122). The control unit (13) electrically connected between the memory unit (12) and the USB connector (11) is used to execute commands and control import and export of data flow.

The computer (30) is electrically connected to the USB connector (11) of the digital key (10) via a USB port (31) and executes the executive file/program (122) in order to access and execute an image recognition application (20).

Specifically, the so-called electronic calculator (calculator or computer) is one machine which depends on a series of electronics-based commands for data processing. As tools used to process information, computers can be divided into numerous categories and include, without limitation, mobile device, personal computer (PC), desktop, Tablet PC, server, Smart Phone and Personal Digital Assistant (PDA).

In addition, the image recognition application (20) comprises computer image operation codes (21), data transfer codes (22) and a computer graphics database (23).

Furthermore, the graphic card (40) comprises an object (41) with messages corresponding to an image signal (231) in the computer graphics database (23).

The webcam (50) is used to access and provide the object (41) to the computer (30) which links the object (41) and a corresponding image signal (231) via computer image operation codes (21) of the image recognition application (20) and executes the data transfer codes (22) in order to display the image signal (231) on one display unit (32) of the computer (30).

Preferably, the control unit (13) comprises a virtual device module (131) which can be preset to be any virtual device among a CD-ROM drive, a floppy disk drive and a floppy disk.

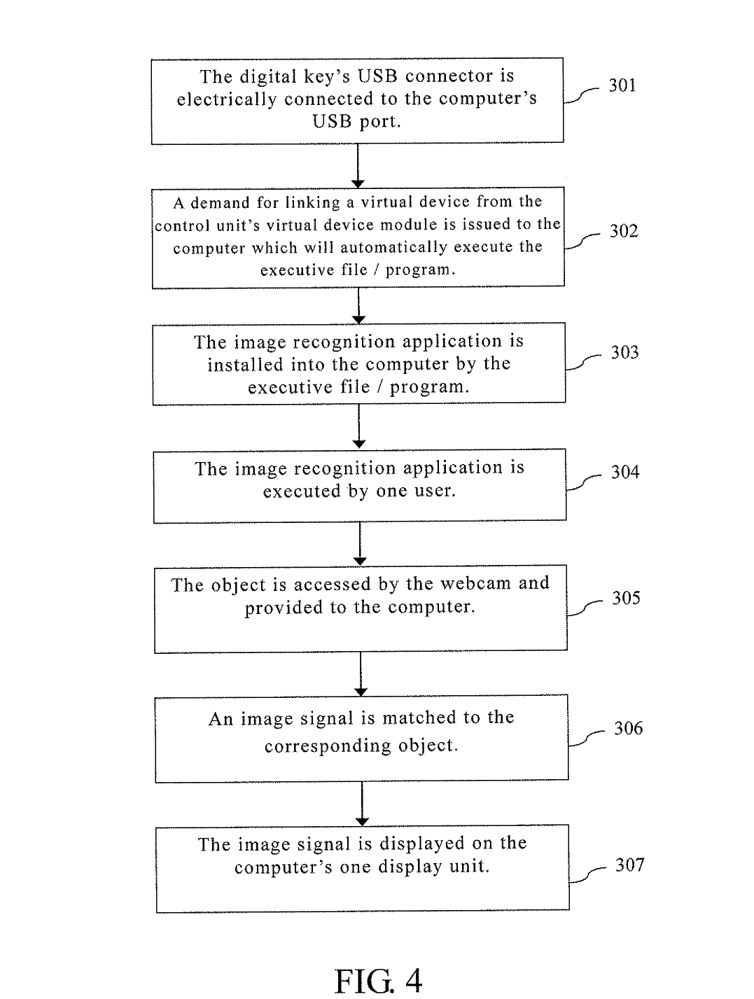

Referring to FIG. 4 which illustrates the operating method of the present invention of an interactive graphic card with a digital key comprises steps as follows: (a) The USB connector (11) of the digital key (10) is electrically connected to the USB port (31) of the computer (30) (Step a: 301); (b) A demand for linking a virtual device from a virtual device module (131) of the control unit (13) is issued to the computer (30) which will automatically execute the executive file/program (122) (Step b: 302); (c) The image recognition application (20) is installed into the computer (30) by the executive file/program (122) (Step e: 303); (d) The image recognition application (20) is executed by one user (Step d: 304); (e) The object (41) is accessed by the webcam (50) and provided to the computer (30) (Step e: 305); (f) Computer image operation codes (21) are executed to match an image signal (231) and the corresponding object (41) (Step f: 306); (g) The image signal (231) is displayed on one display unit (32) (e.g., screen) of the computer (30) by the data transfer codes (22) (Step g: 307).

According to the above steps, any image signal corresponding to an object in a graphic card can be shown on one computer's display unit in order to promote interaction between the graphic card and one user who easily operates one computer equipped with one webcam to execute an image recognition application. Accordingly, the graphic card is effective in creation of innovative and novel feelings via the present invention in addition to preservation of original texts, sounds or messages.

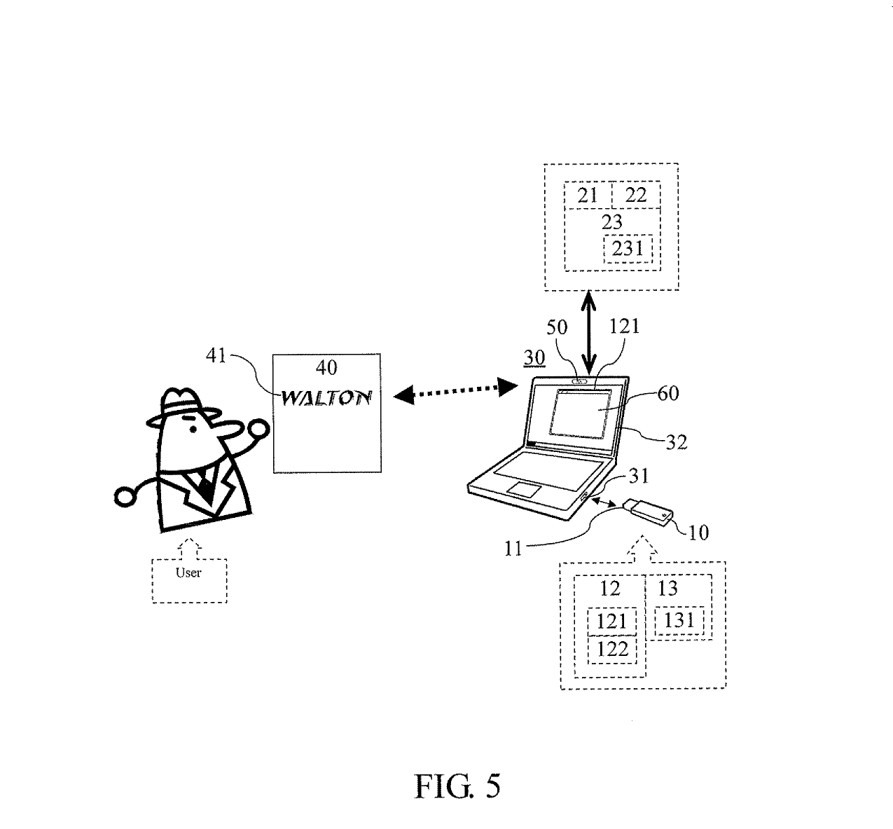

Referring to FIG. 5 which illustrates the second embodiment of the present invention wherein the interactive graphic card with a digital key and its operating method that has been described in the first embodiment and from FIG. 1 to FIG. 4 are marked with the same symbols in FIG. 5 and not repeatedly interpreted.

As shown in FIG. 5, the difference between the second embodiment and the first one is a website (121) saved in the former's memory unit (12) has some web page codes in which the image recognition application (20) is inserted.

As a result, a default browser is called by the executive file/program (122) for the website (121) and the image recognition application (20) is automatically downloaded to and executed in the computer (30) after Step b. Then, Step c and other subsequent steps are executed by the executive file/program (122).

Preferably, the image signal (231) at Step g is displayed on a corresponding web page (60) of the website (121) and the web page (60) is shown on the display unit (32) of the computer (30).

With the above descriptions summarized, the present invention is intended for supply of an interactive graphic card with a digital key and its operating method which is simple and advantageous to interaction between an addressee and a graphic card and is effective in communication of messages and creation of innovative & novel feelings. Therefore, the present invention with effects distinct from traditional graphic cards and referred to as creative work among similar products meets patentability and is applied for the patent.

It must be stressed that the said disclosures demonstrate the preferred embodiments of the present invention only and any equivalent change in disclosures, claims or drawings with respect to the present invention is still within the technical scope protected by the present invention.

What is claimed is:

1. An interactive graphic card with a digital key comprises:
A digital key (10) comprising a USB connector (11), a memory unit (12) and a control unit (13): the memory unit (12) is used to provide readable/writable digital data and has an executive file/program (122); the control unit (13) electrically connected between the memory unit (12) and the USB connector (11) is used to execute commands and control import and export of data flow;
An image recognition application (20) which comprises computer image application codes (21), data transfer codes (22) and a computer graphics database (23);
A computer (30) which is electrically connected to the USB connector (11) of the digital key (10) via a USB port (31) and is able to access and execute the image recognition application (20) due to execution of the executive file/program (122);
A graphic card (40) which comprises an object (41) with messages corresponding to an image signal (231) in the computer graphics database (23);
A webcam (50) which is used to access and provide the object (41) to the computer (30), calculate to match an image signal (231) corresponding to the object (41) via computer image application codes (21) of the image recognition application (20), and execute the data transfer codes (22) for the image signal (231) shown on one display unit (32) of the computer (30).

2. The interactive graphic card with a digital key according to claim 1 wherein the memory unit (12) comprises a website (121) with web page codes in which image recognition application (20) is inserted.

3. The interactive graphic card with a digital key according to claim 2 wherein the image signal (231) corresponding to the object (41) is displayed on one web page (60) of the website (121) and the web page (60) is shown on one display unit (32) of the computer (30).

4. The interactive graphic card with a digital key according to claim 1 wherein the control unit (13) comprises a virtual device module (131) which is preset to be any virtual device among a CD-ROM drive, a floppy disk drive and a floppy disk.

5. An operating method of the interactive graphic card with a digital key comprises steps as follows:
Step a: The digital key's USB connector is electrically connected to the computer's USB port (301);
Step b: A demand for linking a virtual device from the control unit's virtual device module is issued to the computer which will automatically execute the executive file/program (302);
Step c: The image recognition application is installed into the computer by the executive file/program (303);
Step d: The image recognition application is executed by one user (304);
Step e: The object is accessed by the webcam and provided to the computer (305);
Step f: Computer image operation codes are executed to match an image signal and the corresponding object (306); and
Step g: The image signal is displayed on the computer's one display unit by the data transfer codes (307).

6. The operating method of the interactive graphic card with a digital key according to claim 1 wherein a default browser is called by the executive file/program (122) for the website (121) and the image recognition application is automatically downloaded to and executed in the computer (30) after Step b.

7. The operating method of an interactive graphic card with a digital key according to claim 1 wherein the image signal (231) at Step g is displayed on one corresponding web page (60) of the website (121) and the web page (60) is shown on the display unit (32) of the computer (30).
